(19) United States
(12) Patent Application Publication
(10) Pub. No.: US 2006/0009577 A1
(43) Pub. Date: Jan. 12, 2006

(54) Addition reaction curable silicone rubber composition

(75) Inventor: Hiroyasu Hara, Takasaha-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Tokyo (JP)

(21) Appl. No.: 11/176,319

(22) Filed: Jul. 8, 2005

(30) Foreign Application Priority Data
Jul. 9, 2004 (JP) 2004-203872

(51) Int. Cl. C08L 83/04; B32B 27/00

(52) U.S. Cl. 524/862; 524/861; 524/866; 156/329; 428/447

(57) ABSTRACT

Provided is a self-adhesive addition reaction curable silicone rubber composition including (A) 100 parts by mass of an organopolysiloxane containing at least two alkenyl groups bonded to silicon atoms, (B) an organohydrogenpolysiloxane, in sufficient quantity to provide from 0.4 to 10.0 mols of hydrogen atoms bonded to silicon atoms within this component (B) for every 1 mol of alkenyl groups within the entire composition, (C) an effective quantity of a platinum-based catalyst, (D) a curing retarder, and (E) an adhesion imparting agent, in which the blend quantity of the curing retarder of the component (D) is sufficient to ensure that, if a torque value of the composition after standing for 180 minutes at 80° C. following preparation is deemed 100%, the time required for the torque value to reach 90% is no more than 120 minutes. Also provided is a method of bonding a plastic substrate and a silicone rubber, in which the above-stated addition reaction curable silicone rubber composition is cured on the plastic substrate at a temperature of no more than 120° C. The addition reaction curable silicone rubber composition is able to be cured even in the presence of curing inhibiting substances, and is very useful as a silicone adhesive.

### BACKGROUND OF THE INVENTION

1. Field of the Invention

The present invention relates to a self-adhesive addition reaction curable silicone rubber composition with superior adhesiveness, which is resistant to the effects of curing inhibiting substances derived from the plastic or the like that constitutes the adherend.

2. Description of the Prior Art

Silicone rubber compositions that use a platinum compound as the curing catalyst are used in a wide variety of applications as a result of their superior curability, and can be applied to both millable silicone rubbers and liquid silicone rubbers. These liquid silicone rubber compositions, in particular, are used as adhesives, casting materials, and LIMS (Liquid Injection Molding System) materials and the like. In either type of silicone rubber, the silicone rubber composition is mixed and/or heated to promote a cross-linking reaction, thereby generating a cured rubber product. In terms of workability at the time of use, one-part type compositions (full compounds) are preferred.

In one-part type compositions, curing retarders are used to ensure favorable storability of the composition prior to use, and heating must be used to cure such one-part type compositions. When a one-part type composition is used as an addition reaction curable silicone adhesive, the adherend such as a metal, resin, or component or the like is also heated at the time of heat curing. Resins contain substances that have a curing inhibiting effect on silicone adhesives, and particularly on addition reaction curable silicone adhesives. As a result, on occasion, the silicone adhesive at the contact interface, or even the entire silicone adhesive sample, may not cure. This phenomenon is particularly marked when the thickness of the adhesive layer is reduced to less than 0.5 mm.

### SUMMARY OF THE INVENTION

An object of the present invention is to provide a self-adhesive addition reaction curable silicone rubber composition, which is able to be cured even in the presence of curing inhibiting substances derived from the plastic or the like that constitutes the adherend, and is very useful as a silicone adhesive used for bonding electrical components, electronic components, and vehicle-mounted components.

In order to achieve the above object, the present invention provides an addition reaction curable silicone rubber composition comprising:

(A) 100 parts by mass of an organopolysiloxane containing at least two alkenyl groups bonded to silicon atoms, represented by an average composition formula (1) shown below:
R¹ₐR²_{b}SiO_{(4-a-b)/2} (1)
(wherein, each R¹ group represents an identical or different unsubstituted or substituted monovalent hydrocarbon group that contains no aliphatic unsaturated bonds, R² represents an alkenyl group, a represents a number from 0.96 to 2.00, b represents a number from 0.0001 to 0.5, and a+b represents a number within a range from 1.90 to 2.04),

(B) an organohydrogenpolysiloxane represented by an average composition formula (2) shown below:
R³_{c}H_{d}SiO_{(4-c-d)/2} (2)
(wherein, each R³ group represents an identical or different unsubstituted or substituted monovalent hydrocarbon group that contains no aliphatic unsaturated bonds, c represents a number from 0.70 to 2.00, d represents a number from 0.01 to 1.2, and c+d represents a number within a range from 1 to 3), in sufficient quantity to provide from 0.4 to 10.0 mols of hydrogen atoms bonded to silicon atoms within this component (B) for every 1 mol of alkenyl groups within the entire composition,

(C) an effective quantity of a platinum-based catalyst,

(D) a curing retarder, and

(E) an adhesion imparting agent, wherein

the blend quantity of the curing retarder of the component (D) is sufficient to ensure that, if a torque value of the composition after standing for 180 minutes at 80° C. following preparation is deemed 100%, the time required for the torque value to reach 90% is no more than 120 minutes.

An addition reaction curable silicone rubber composition of the present invention can be cured favorably even in the presence of curing inhibiting substances derived from the adherend, and exhibits a high level of curability, while maintaining excellent storability. In addition, when a composition of the present invention is heat cured on a plastic, the occurrence of voids (bubbles caused by gas generated from either the composition or the plastic) can be suppressed to very low levels. Accordingly, an addition reaction curable silicone rubber composition of the present invention is very useful as a highly reliable adhesive for use with electrical components, electronic components, and vehicle-mounted components.

### DETAILED DESCRIPTION OF THE PREFERRED EMBODIMENTS

As follows is a more detailed description of the present invention.

[Component (A)]

The component (A) is the primary component (the base polymer) of a composition of the present invention, and is an organopolysiloxane containing at least two alkenyl groups bonded to silicon atoms, represented by an average composition formula (1) shown below:
R¹ₐR²_{b}SiO_{(4-a-b)/2} (1)
(wherein, each R¹ group represents an identical or different unsubstituted or substituted monovalent hydrocarbon group that contains no aliphatic unsaturated bonds and preferably contains from 1 to 12, and even more preferably from 1 to 8, carbon atoms, R² represents an alkenyl group that preferably contains from 2 to 8, and even more preferably from 2 to 4, carbon atoms, a represents a number from 0.96 to 2.00, and preferably from 1.5 to 2.00, and even more preferably from 1.9 to 2.00, b represents a number from 0.0001 to 0.5, and preferably from 0.001 to 0.2, and even more preferably from 0.001 to 0.1, and a+b represents a number within a range from 1.90 to 2.04, and preferably from 1.98 to 2.03, and even more preferably from 2.00 to 2.02). There are no particular restrictions on the molecular structure of the component (A), and straight chain, branched, cyclic, or network structures are all suitable, although normally, straight chain diorganopolysiloxanes in which the principal chain is formed from repeating diorganosiloxane units, and both terminals are blocked with triorganosiloxy groups, are preferred. Furthermore, the component (A) may be either a polymer comprising a single siloxane unit, or a copolymer comprising two or more different siloxane units.

Specific examples of R¹ include alkyl groups such as methyl groups, ethyl groups, propyl groups, isopropyl groups, butyl groups, hexyl groups, octyl groups, and dodecyl groups, cycloalkyl groups such as cyclopentyl groups and cyclohexyl groups, aryl groups such as phenyl groups, tolyl groups, xylyl groups, and naphthyl groups, aralkyl groups such as benzyl groups, phenylethyl groups, and phenylpropyl groups, and groups in which at least one of the hydrogen atoms within these hydrocarbon groups have been substituted with a halogen atom such as a fluorine or chlorine atom, or a nitrile group, including trifluoropropyl groups, chloromethyl groups, and cyanoethyl groups. Of the different possible components (A), components in which all of the R¹ groups are methyl groups are particularly preferred in terms of chemical stability and ease of synthesis. In such components, a portion of these methyl groups may be substituted with phenyl groups or trifluoropropyl groups.

Specific examples of R² include vinyl groups, allyl groups, propenyl groups, isopropenyl groups, butenyl groups, and pentenyl groups. The R² groups are preferably vinyl groups or allyl groups. Of the different possible components (A), components in which all of the R² groups are vinyl groups are particularly preferred in terms of ease of synthesis and chemical stability.

The viscosity at 25° C. of the organopolysiloxane of the component (A) is preferably within a range from 10 to 5,000,000 mm²/sec., and even more preferably from 50 to 5,000,000 mm²/sec. Viscosity values within this range are preferred for the reasons listed below. Prior to curing, the viscosity of the composition can be suppressed to a level that ensures satisfactory workability. Following curing, the cured product can be prevented from becoming brittle, meaning the cured product can be more easily deformed or molded when the substrate is molded. Combinations of two or more different organopolysiloxanes can be used as the component (A), provided the viscosity following mixing falls within the above range.

[Component (B)]

The component (B) functions as a cross-linking agent, and is an organohydrogenpolysiloxane represented by an average composition formula (2) shown below:
R³_{c}H_{d}SiO_{(4-c-d)/2} (2)
(wherein, each R³ group represents an identical or different unsubstituted or substituted monovalent hydrocarbon group that contains no aliphatic unsaturated bonds and preferably contains from 1 to 12, and even more preferably from 1 to 8, carbon atoms, c represents a number from 0.70 to 2.00, and preferably from 1.00 to 2.00, and even more preferably from 1.50 to 1.95, d represents a number from 0.01 to 1.2, and preferably from 0.02 to 1.0, and even more preferably from 0.05 to 0.95, and c+d represents a number within a range from 1 to 3, and preferably from 1.5 to 2.7, and even more preferably from 1.9 to 2.5). Because this component (B) functions as a cross-linking agent for forming a three dimensional structure, by reacting, in the presence of the platinum-based catalyst of the component (C) described below, with the alkenyl groups within the composition, and particularly the alkenyl groups bonded to silicon atoms within the component (A), the component must contain at least 2 (typically from 2 to 200), and preferably 3 or more, and even more preferably from 3 to 100, hydrogen atoms bonded to silicon atoms (namely, SiH groups) within each molecule.

There are no particular restrictions on the molecular structure of the component (B), and straight chain, branched, cyclic, or network structures are all suitable. Furthermore, the component (B) may be either an organohydrogenpolysiloxane formed solely from siloxane units containing at least one silicon-hydrogen bond (such as (H)(R³)₂SiO_{1/2} units, (H)(R³)SiO_{2/2} units, and (H)SiO_{3/2} units), or a copolymer which comprises these types of siloxane units, together with one or more units selected from a group consisting of triorganosiloxane units ((R³)₃SiO_{1/2} units), diorganosiloxane units ((R³)₂SiO_{2/2} units), monoorganosiloxane units ((R³)SiO_{3/2} units), and SiO₂ units. From the viewpoints of ease of synthesis and ensuring favorable co-solubility with the component (A), the polymerization degree of the component (B) is typically a value which results in a total number of silicon atoms of 2 to 300, and preferably from 4 to 150.

Suitable examples of the above group R³ include the same monovalent hydrocarbon groups presented as examples of the aforementioned group R¹. Of the different possible components (B), components in which all of the R³ groups are methyl groups are particularly preferred in terms of ease of synthesis and chemical stability. In such components, if necessary, a portion of these methyl groups may be substituted with phenyl groups or trifluoropropyl groups.

Specific examples of the organohydrogenpolysiloxane of the component (B) include 1,1,3,3-tetramethyldisiloxane, 1,3,5,7-tetramethylcyclotetrasiloxane, cyclic polymers of methylhydrogensiloxane, cyclic copolymers of dimethylsiloxane and methylhydrogensiloxane, methylhydrogenpolysiloxane with both terminals blocked with trimethylsiloxy groups, copolymers of dimethylsiloxane and methylhydrogensiloxane with both terminals blocked with trimethylsiloxy groups, dimethylpolysiloxane with both terminals blocked with dimethylhydrogensiloxy groups, copolymers of dimethylsiloxane and methylhydrogensiloxane with both terminals blocked with dimethylhydrogensiloxy groups, copolymers of dimethylsiloxane, methylhydrogensiloxane, and diphenylsiloxane with both terminals blocked with dimethylhydrogensiloxy groups, copolymers of methylhydrogensiloxane and diphenylsiloxane with both terminals blocked with trimethylsiloxy groups, copolymers of methylhydrogensiloxane, diphenylsiloxane, and dimethylsiloxane with both terminals blocked with trimethylsiloxy groups, copolymers comprising (CH₃)₂HSiO_{1/2} units and SiO_{4/2} units, copolymers comprising (CH₃)₂HSiO_{1/2} units, (CH₃)₃SiO_{1/2} units, and SiO_{4/2} units, and copolymers comprising (CH₃)₂HSiO_{1/2} units, SiO_{4/2} units, and (C₆H₅)SiO_{3/2} units.

This component (B) may use either a single organohydrogenpolysiloxane described above, or a combination of two or more different materials.

The blend quantity of the component (B) must be sufficient to provide from 0.4 to 10.0 mols, and preferably from 1.2 to 5.0 mols, of hydrogen atoms bonded to silicon atoms within the component (B) for each 1 mol of alkenyl groups within the composition (and in particular, alkenyl groups bonded to silicon atoms within the component (A)). If this quantity of hydrogen atoms is less than 0.4 mols, then curing of the composition may be inadequate, making it difficult to obtain a cured product with the required strength. In contrast, if the quantity of hydrogen atoms exceeds 10 mols, then the composition may foam on curing, and the physical properties of the cured product may be prone to changes over time.

[Component (C)]

Examples of the platinum-based catalyst of the component (C) include platinum and platinum compounds. The component (C) has a function of accelerating the addition reaction (hydrosilylation reaction) between the alkenyl group-containing organopolysiloxane of the component (A) and the organohydrogenpolysiloxane of the component (B). The component (C) can use any of the conventional hydrosilylation reaction catalysts. Specific examples of the catalyst include platinum black, chloroplatinic acid, alcohol-modified products of chloroplatinic acid, and complexes of chloroplatinic acid with olefins, aldehydes, vinylsiloxanes or acetylene alcohols.

In those cases where it is necessary to suppress the contamination of the composition of the present invention with chloride ions, a platinum-based catalyst that contains essentially no chloride ions can be used. Examples of such catalysts include zero valent platinum complexes containing no more than 5 ppm of chloride ions. Specific examples of these catalysts include the vinylsiloxane-platinum complexes disclosed in U.S. Pat. No. 3,715,334, U.S. Pat. No. 3,775,452, and U.S. Pat. No. 3,814,730.

The quantity added of the component (C) need only be sufficient to ensure effective activity as a hydrosilylation reaction catalyst, and can be increased or decreased in accordance with the desired curing rate. A typical quantity, calculated as the mass of platinum atoms relative to the total mass of the composition is within a range from 0.1 to 2,000 ppm, with quantities from 0.5 to 500 ppm being preferred, and quantities from 1 to 200 ppm being the most desirable.

[Component (D)]

The component (D) is a curing retarder, which provides the composition of the present invention with sufficient storability to enable its use as either a one-part type or two-part type composition. There are no particular restrictions on the structure of the component (D), provided it is capable of inhibiting the curing of the composition of the present invention under conditions other than the desired curing conditions. Specific examples of the curing retarder include acetylene alcohol-based compounds, triallyl isocyanurate-based compounds, vinyl group-containing polysiloxanes, alkyl maleates, hydroperoxides, tetramethylethylenediamine, benzotriazole, and mixtures thereof. Of these, acetylene alcohol-based compounds and triallyl isocyanurate-based compounds are particularly preferred as they provide the composition of the present invention with excellent storability with no loss of composition curability.

Specific examples of the acetylene alcohol-based compounds include acetylene alcohols, and silane-modified or siloxane-modified products thereof.

Amongst the acetylene alcohols, compounds in which the ethynyl group and the hydroxyl group are bonded to the same carbon atom are preferred. Specific examples include the compounds shown below.

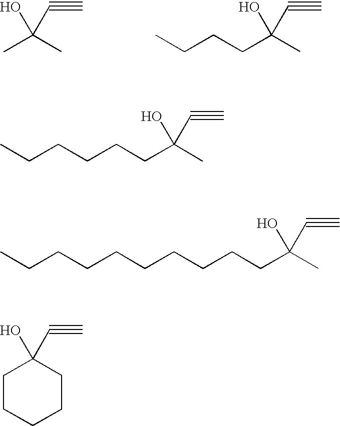

Furthermore, silane-modified or siloxane-modified products of acetylene alcohols refer to compounds in which the hydroxyl group of the acetylene alcohol has been converted to a Si—O—C linkage through silylation with either an alkoxysilane or an alkoxysiloxane. Specific examples include the compounds shown below. 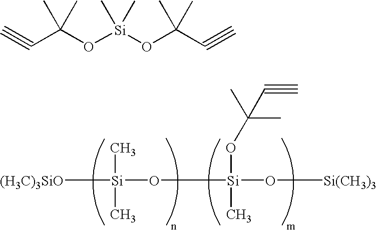
(wherein, n represents an integer from 0 to 50, and m represents an integer from 1 to 50, and preferably from 3 to 50)

Furthermore, specific examples of triallyl isocyanurate-based compounds include triallyl isocyanurate, alkoxysilyl-substituted triallyl isocyanurates, in which from 1 to 3 alkoxysilyl groups such as trimethoxysilyl groups have been added to the allyl groups, and siloxane-modified products (derivatives) thereof in which the alkoxysilyl groups have undergone a hydrolysis-condensation with one another.

Triallyl isocyanurate is represented by the formula shown below.

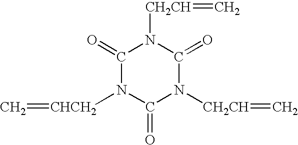

Alkoxysilyl-substituted products of triallyl isocyanurate include the compounds shown below, and compounds in which the methoxy groups of the compounds shown below have been substituted with ethoxy groups, propoxy groups, isopropoxy groups, butoxy groups, isobutoxy groups, or tert-butoxy groups or the like.

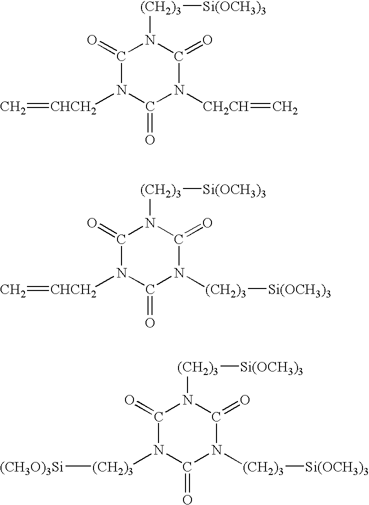

The blend quantity of the component (D) is sufficient to ensure that, if the torque value of the composition after standing for 180 minutes at 80° C. following preparation is deemed 100%, the time required for the torque value to reach 90% (hereafter abbreviated as T90) is no more than 120 minutes, and preferably no more than 100 minutes. If T90 exceeds 120 minutes, then the composition becomes difficult to cure in the presence of curing inhibiting substances.

The torque detection-based curability evaluation device used for measuring the curability is a type of rheometer, as prescribed in JIS K 6300. An example of a commercially available device is the MDR2000 (brand name) manufactured by Alpha Technologies Ltd.

In order to ensure a satisfactory level of storability for the composition, the blend quantity of the component (D) is preferably sufficient to ensure an uncured time period (that is, an introducing time period for curing or “pot life”) at 40° C. of at least 168 hours, and even more preferably 180 hours or longer. In this description, the term “uncured time period” refers to the time period during which the composition either maintains self-flowability, or is still able to undergo plastic deformation, whereas the term “curing completion” refers to the point in time where the aforementioned torque value of the composition has reached 90% or greater.

[Component (E)]

The component (E) is an adhesion imparting agent used for imparting self-adhesiveness to the composition of the present invention. This self-adhesiveness is preferably particularly strong relative to metals and organic resins. Examples of this component include organosilicon compounds such as silanes containing at least one, and preferably two or more, functional groups selected from a group consisting of alkenyl groups such as vinyl groups, (meth)acryloxy groups, hydrosilyl groups (SiH groups), epoxy groups, alkoxysilyl groups, carbonyl groups, and phenyl groups, and cyclic or straight chain siloxanes containing from 2 to 30, and preferably from 4 to 20, silicon atoms, as well as non-silicon-based organic compounds (with no silicon atoms within the molecular structure), containing from 1 to 4, and preferably from 1 to 2, aromatic rings such as monovalent to tetravalent, and preferably bivalent to tetravalent, phenylene structures within each molecule, and also containing at least one, and preferably from 2 to 4, functional groups (such as alkenyl groups or (meth)acryloxy groups) within each molecule that can contribute to the hydrosilylation addition reaction, and which may also contain oxygen atoms within the molecule. Specific examples of the component (E) include the compounds shown below.

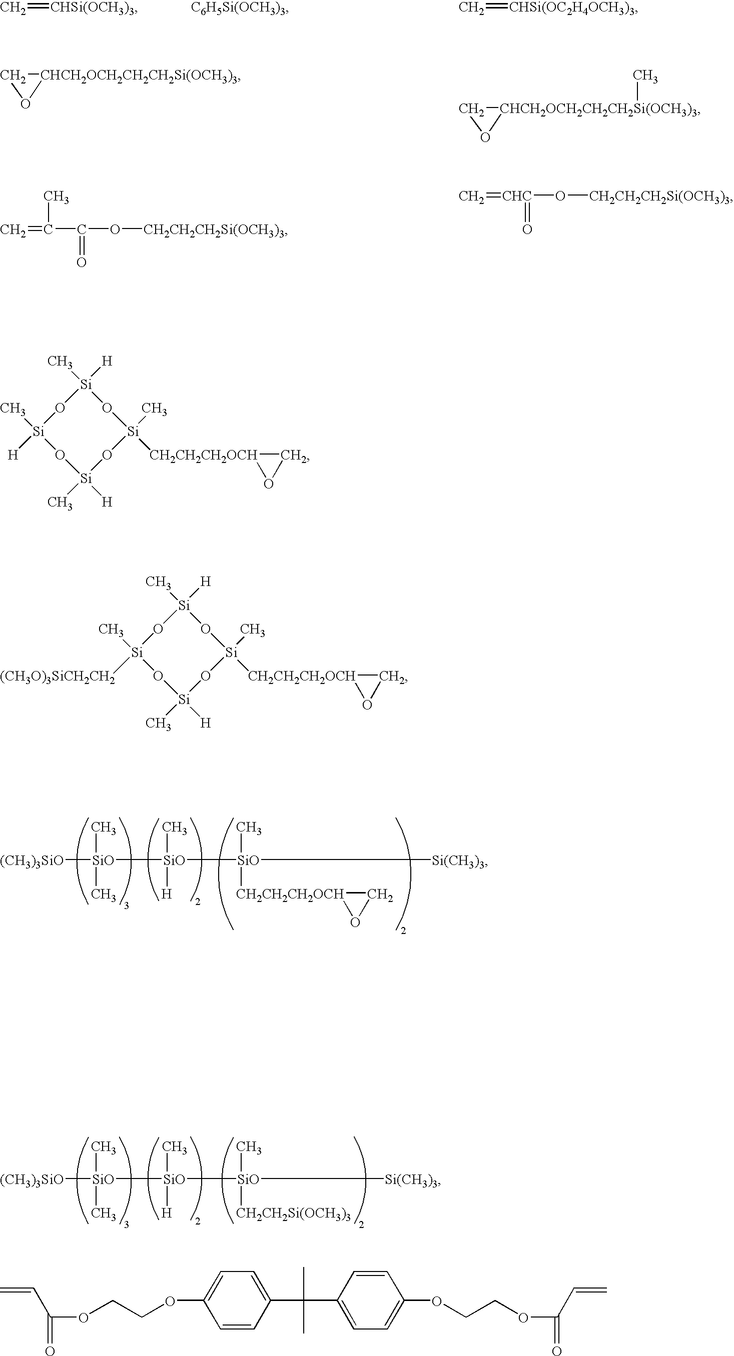

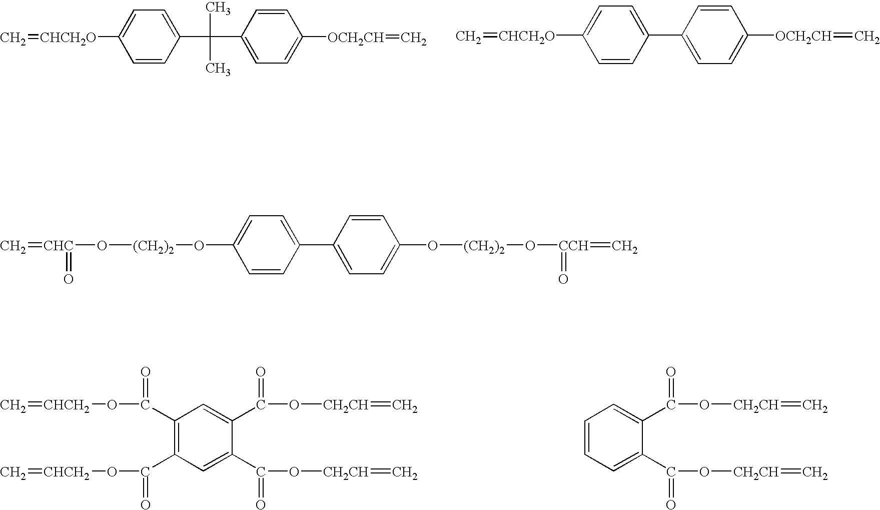

The component (E) may use either a single compound, or a combination of two or more different compounds, although from the viewpoint of achieving favorable adhesiveness to substrates, a combination of an organosilicon compound and a non-silicon-based organic compound is preferred.

The blend quantity of the component (E) should be sufficient to ensure a favorable level of self-adhesion of the composition of the present invention to an adherend, and particularly to metals and organic resins, and this blend quantity is typically within a range from 0.01 to 20 parts by mass, and preferably from 0.1 to 5 parts by mass, per 100 parts by mass of the component (A).

[Other Components]

Other components may also be added to a composition of the present invention, provided the quantity in which they are added does not impair the effects of the composition, and examples of such additives include reinforced silica fillers, non-reinforcing fillers such as quartz powder, diatomaceous earth, and calcium carbonate, colorants such as inorganic pigments like cobalt blue, and organic dyes, and heat resistance or flame retardancy improvement agents such as cerium oxide, zinc carbonate, manganese carbonate, red iron oxide, titanium oxide, and carbon black. In addition, in order to improve the conductive stability, carbon black or graphite may also be added to the composition of the present invention in a powdered form, as whiskers, or in a highly structured form. Moreover, a catalytic assistant or the like may also be added to improve the curing speed.

There are no particular restrictions on the form of the composition of the present invention, and either a one-part type or two-part type composition is suitable, although in terms of workability at the time of use, a one-part type composition is preferred.

[Applications for the Composition]

A composition of the present invention can be applied to a suitable substrate, in accordance with the intended application, and then cured by heating. There are no particular restrictions on the curing conditions for a composition of the present invention, which will vary depending on the quantity of the composition. The curing temperature is preferably within a range from 20 to 120° C., and even more preferably from 60 to 100° C. The curing time is typically within a range from 0.5 to 360 minutes.

A composition of the present invention can be used as an adhesive. There are no particular restrictions on the adherends to which the adhesive comprising the composition of the present invention can be applied, and suitable adherends include metals and organic resins, although plastic adherends are preferred. Specific examples of suitable plastics include polybutylene terephthalate (PBT), polyphenylene sulfide (PPS), nylon 6, nylon 66, and polyphthalamide (PPA). By curing a composition of the present invention on a plastic substrate at a temperature of no more than 120° C., and preferably at a temperature within a range from 20 to 120° C., and even more preferably from 60 to 100° C., the plastic substrate and the silicone rubber can be bonded together.

The present invention also provides a method of producing a laminate comprising a layer of a substrate and a layer, adhered to said layer of said substrate, of a cured product of the addition reaction curable silicone rubber composition of the present invention, said method comprising the steps of applying said composition to said substrate and curing said composition on said substrate at a temperature of no more than 120° C., and preferably at a temperature within a range from 20 to 120° C., and even more preferably from 60 to 100° C. Examples of said substrate include the adherends exemplified above, although plastic substrate is preferred.

Moreover, the present invention also provides a method of bonding two substrates, comprising the steps of sandwiching the addition reaction curable silicone rubber composition of the present invention between said two substrates and curing said composition at a temperature of no more than 120° C., and preferably at a temperature within a range from 20 to 120° C., and even more preferably from 60 to 100° C. In an embodiment, the composition is applied to a first substrate, and subsequently a second substrate is superposed on the composition applied to the first substrate, followed by curing said composition at a temperature of no more than 120° C., and preferably at a temperature within a range from 20 to 120° C., and even more preferably from 60 to 100° C. In another embodiment, the composition is applied to each of a first substrate and a second substrate, and subsequently the side of the first substrate on which the composition has been applied is superposed on the side of the second substrate on which the composition has been applied, followed by curing said composition at a temperature of no more than 120° C., and preferably at a temperature within a range from 20 to 120° C., and even more preferably from 60 to 100° C. In still another embodiment, the composition is applied to the gap between two substrates, and subsequently the composition is cured at a temperature of no more than 120° C., and preferably at a temperature within a range from 20 to 120° C., and even more preferably from 60 to 100° C. Materials of said two substrates include, for example, the materials exemplified above for the adherends, although plastic substrates are preferred. Materials of said two substrates may be the same as or different from each other.

### EXAMPLES

As follows is a description of specifics of the present invention, based on a series of examples and comparative examples, although the present invention is in no way restricted to the examples presented below.

The components (A) through (F) described below were mixed together in the proportions shown in Table 1.
(A) Organopolysiloxane: 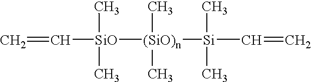
(wherein, n represents an integer that results in a viscosity at 25° C. for the organopolysiloxane of 10,000 mm²/sec., specifically an integer of approximately 500)
(B) Organohydrogenpolysiloxane: 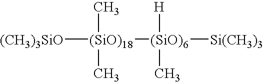
(C) Platinum-Based Catalyst:
toluene solution of a platinum-divinyltetramethyldisiloxane complex
(D) Curing Retarder:
50 mass % toluene solution of ethynylcyclohexanol
(E-1) Adhesion imparting agent 1: 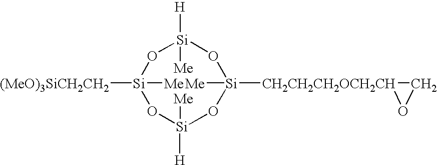
(wherein, Me represents a methyl group)
(E-2) Adhesion Imparting Agent 2: 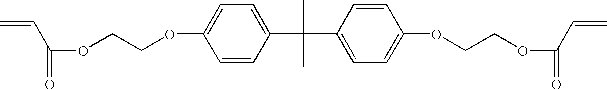
(F) Silica:

fumed silica (R8200, manufactured by Degussa A G)

TABLE 1

| | | | Example | Example | Example | Example | Example | Comparative | Comparative |
|---|---|---|---|---|---|---|---|---|---|
| Composition | | | 1 | 2 | 3 | 4 | 5 | example 1 | example 2 |
| (A) organopolysiloxane | | | 100 | 100 | 100 | 100 | 100 | 100 | 100 |
| (parts by mass) | | | | | | | | | |
| (B) hydrogenpolysiloxane | | | 3 | 3 | 3 | 3 | 3 | 3 | 3 |
| (parts by mass) | | | | | | | | | |
| (C) platinum-based catalyst | | | 15 | 15 | 15 | 15 | 15 | 15 | 15 |
| (ppm ^{(note)}) | | | | | | | | | |
| (D) curing retarder | | | 0.1 | 0.12 | 0.15 | 0.2 | 0.25 | 0.3 | 0.4 |
| (parts by mass) | | | | | | | | | |
| (E-1) adhesion imparting agent 1 | | | 3 | 3 | 3 | 3 | 3 | 3 | 3 |
| (parts by mass) | | | | | | | | | |
| (E-2) adhesion imparting agent 2 | | | 0.1 | 0.1 | 0.1 | 0.1 | 0.1 | 0.1 | 0.1 |
| (parts by mass) | | | | | | | | | |
| (F) silica | | | 10 | 10 | 10 | 10 | 10 | 10 | 10 |
| (parts by mass) | | | | | | | | | |
| T90 at 80° C. | | | 31 | 59 | 75 | 85 | 110 | 134 | 172 |
| (minutes) | | | | | | | | | |
| Uncured time period at 40° C. | | | 180 | 230 | 285 | 350 | 450 | 610 | 780 |
| (hours) | | | | | | | | | |
| PPS bonding tests | | | | | | | | | |
| Curing temperature | Thickness of | | | | | | | | |
| and curing time | adhesive | | | | | | | | |
| 80° C. for 120 min. | 2 | mm | ∘ | ∘ | ∘ | ∘ | ∘ | Δ | x |
| | 1.0 | mm | ∘ | ∘ | ∘ | ∘ | ∘ | x | x |
| | 0.5 | mm | ∘ | ∘ | ∘ | ∘ | ∘ | x | x |
| | 0.3 | mm | ∘ | ∘ | ∘ | ∘ | x | x | x |
| 100° C. for 60 min. | 2 | mm | ∘ | ∘ | ∘ | ∘ | ∘ | ∘ | ∘ |
| | 1.0 | mm | ∘ | ∘ | ∘ | ∘ | ∘ | ∘ | ∘ |
| | 0.5 | mm | ∘ | ∘ | ∘ | ∘ | ∘ | Δ | x |
| | 0.3 | mm | ∘ | ∘ | ∘ | ∘ | ∘ | x | x |
| 120° C. for 30 min. | 2 | mm | ∘ | ∘ | ∘ | ∘ | ∘ | ∘ | ∘ |
| | 1.0 | mm | ∘ | ∘ | ∘ | ∘ | ∘ | ∘ | ∘ |
| | 0.5 | mm | ∘ | ∘ | ∘ | ∘ | ∘ | ∘ | ∘ |
| | 0.3 | mm | ∘ | ∘ | ∘ | ∘ | ∘ | x | x |

| | | | | | | | |
|---|---|---|---|---|---|---|---|
| occurrence | − | − | − | − | − | + | ++ |
| of voids | | | | | | | |

^{(note)} The quantity added of the platinum compound is presented as a mass of platinum atoms relative to the total mass of the composition.

[Measurement of T90 at 80° C.]

The curing characteristics of each composition at 80° C. were measured using a rheometer (MDR2000, manufactured by Alpha Technologies Ltd.). The torque value of the composition after standing for 180 minutes at 80° C. was deemed to be 100%, and the time required for the torque value to reach 90% was recorded as T90 (minutes).

[Measurement of the Uncured Time Period at 40° C.]

The composition was placed inside a 100 ml glass bottle and sealed, and then stored in a thermostatic oven at 40° C. The time period during which the composition retained self-flowability, or was still able to undergo plastic deformation, was recorded as the uncured time period.

[PPS Bonding Tests]

Spacers of the thickness shown in Table 1 were sandwiched between two PPS sheets (Sasteel GS-40, manufactured by Tosoh Corporation), and the composition was then poured into the thus formed gap between the two sheets, and heated under the conditions shown in Table 1. The symbol “O” is used to indicate that the composition cured completely, the symbol “Δ” to indicate that the composition failed to cure at the interface with the PPS, and the symbol “x” to indicate that the entire composition failed to cure.

Furthermore, in the case of the test conducted using a curing temperature of 120° C., a curing time of 30 minutes, and an adhesive thickness of 0.3 mm, the composition was also inspected for the occurrence of voids. The symbol—is used to indicate the occurrence of absolutely no voids, whereas the symbol “++” is used to indicate the highest density of void occurrence. The symbol “+” indicates void occurrence at an intermediate density.

[Evaluations]

The compositions of the examples exhibited superior curability to the compositions of the comparative examples in the PPS bonding tests. Furthermore, faster composition curing times resulted in lower levels of void occurrence.

What is claimed is:

1. An addition reaction curable silicone rubber composition comprising:
(A) 100 parts by mass of an organopolysiloxane containing at least two alkenyl groups bonded to silicon atoms, represented by an average composition formula (1) shown below:
R¹ₐR²_{b}SiO_{(4-a-b)/2} (1)
(wherein, each R¹ group represents an identical or different unsubstituted or substituted monovalent hydrocarbon group that contains no aliphatic unsaturated bonds, R² represents an alkenyl group, a represents a number from 0.96 to 2.00, b represents a number from 0.0001 to 0.5, and a+b represents a number within a range from 1.90 to 2.04),
(B) an organohydrogenpolysiloxane represented by an average composition formula (2) shown below:
R³_{c}H_{d}SiO_{(4-c-d)/2} (2)
(wherein, each R³ group represents an identical or different unsubstituted or substituted monovalent hydrocarbon group that contains no aliphatic unsaturated bonds, c represents a number from 0.70 to 2.00, d represents a number from 0.01 to 1.2, and c+d represents a number within a range from 1 to 3), in sufficient quantity to provide from 0.4 to 10.0 mols of hydrogen atoms bonded to silicon atoms within said component (B) for every 1 mol of alkenyl groups within said composition,
(C) an effective quantity of a platinum-based catalyst,
(D) a curing retarder, and
(E) an adhesion imparting agent, wherein
a blend quantity of said curing retarder of said component (D) is sufficient to ensure that, if a torque value of said composition after standing for 180 minutes at 80° C. following preparation is deemed 100%, a time required for said torque value to reach 90% is no more than 120 minutes.

2. The addition reaction curable silicone rubber composition according to claim 1, wherein said composition is a one-part type composition.

3. The addition reaction curable silicone rubber composition according to claim 1, wherein an introducing time period for curing at 40° C. is at least 168 hours.

4. The addition reaction curable silicone rubber composition according to claim 1, wherein said component (D) is an acetylene alcohol-based compound or a triallyl isocyanurate-based compound.

5. The addition reaction curable silicone rubber composition according to claim 4, wherein said component (D) is an acetylene alcohol-based compound, and the acetylene alcohol-based compound is an acetylene alcohol, a silane-modified product thereof, or a siloxane-modified product thereof.

6. The addition reaction curable silicone rubber composition according to claim 4, wherein said component (D) is a triallyl isocyanurate-based compound, and the triallyl isocyanurate-based compound is triallyl isocyanurate, an alkoxysilyl-substituted triallyl isocyanurate, in which from 1 to 3 alkoxysilyl groups have been added to the allyl groups, and a siloxane-modified product thereof in which the alkoxysilyl groups have undergone a hydrolysis-condensation with one another.

7. The addition reaction curable silicone rubber composition according to claim 1, wherein said adhesion imparting agent of said component (E) combines an organosilicon compound and a non-silicon-based organic compound.

8. An adhesive comprising the addition reaction curable silicone rubber composition according to claim 1.

9. The adhesive according to claim 6, wherein said adhesive is used for bonding plastic.

10. The adhesive according to claim 7, wherein said plastic is polybutylene terephthalate, polyphenylene sulfide, nylon 6, nylon 66, or polyphthalamide.

11. A method of producing a laminate comprising a layer of a substrate and a layer, adhered to said layer of said substrate, of a cured product of the addition reaction curable silicone rubber composition according to claim 1, said method comprising the steps of:
applying said composition to said substrate and
curing said composition on said substrate at a temperature of no more than 120° C.

12. A method of bonding two substrates, comprising the steps of:
sandwiching the addition reaction curable silicone rubber composition according to claim 1 between said two substrates and
curing said composition at a temperature of no more than 120° C.
